(19) United States
(12) Patent Application Publication
(10) Pub. No.: US 2002/0071132 A1
(43) Pub. Date: Jun. 13, 2002

(54) Optical printing apparatus

(76) Inventors: Keiki Yamada, Tokyo (JP); Ichiro Furuki, Tokyo (JP); Hiroshi Ito, Tokyo (JP)

Correspondence Address: BIRCH STEWART KOLASCH & BIRCH, PO BOX 747, FALLS CHURCH, VA, 22040-0747, US

(21) Appl. No.: 09/837,165

(22) Filed: Apr. 19, 2001

(30) Foreign Application Priority Data
Jun. 21, 2000 (JP) 2000-186267
Oct. 5, 2000 (JP) 2000-306251

(51) Int. Cl. G06F 15/00

(52) U.S. Cl. 358/1.9

(57) ABSTRACT

An optical printing apparatus capable of providing a high-quality image even on a photosensitive printing medium in which a chromophore (i.e., color-generating) density is nonlinear with respect to a quantity of exposure light. A chromophore density characteristic representative of the relation between a quantity of exposure light and a density is determined, and input image data represented by a first gradation is converted into corresponding exposure level data represented by a second gradation greater than the first gradation in accordance with the chromophore density characteristic. A print head is driven to expose the photosensitive printing medium according to the exposure level data, whereby there is obtained an image of a linear density with respect to the image data.

This application is based on Application No. 2000-186267 filed in Japan on Jun. 21, 2000 and Application No. 2000-306251 filed in Japan on Oct. 5, 2000, the contents of which are hereby incorporated by reference.

### BACKGROUND OF THE INVENTION

1. Field of the Invention

The present invention relates to an optical printing apparatus for exposing a photosensitive printing medium to light to form a gradation image thereon, and more specifically, to such an optical printing apparatus that has a multitude of light emitting elements such as light emitting diodes (LEDs), electronic luminescences (ELs) etc., or switching elements such as liquid crystal shutter elements, etc., arranged in a row or a plurality of rows and controls the respective elements independently in accordance with image data.

2. Description of the Related Art

Many optical printing apparatuses for performing exposure on a photosensitive printing medium to form a gradation image thereon have been developed and made commercially available in the markets as those using instant films, simultaneous color paper, etc.

FIG. 19 is a perspective view illustrating the construction of a conventional print head for an optical printing apparatus disclosed in Japanese Patent Application Laid-Open No. No.7-256928 for example. In this figure, white light from a halogen point light source 100 is separated into red, green and blue light by means of a color liquid crystal shutter 101, and continuously irradiated to an end face of an acrylic rod 102 in a time shifted manner. Here, note that the acrylic rod 102 is covered with a reflection foil, on which aluminum, etc., is vapor-deposited except for a light emitting face thereof, and it has a function of converting incident light entered from an end thereof into linear or line-shaped light. Thus, red, green and blue linear light is continuously irradiated to a monochrome shutter array 103 in a time shifted manner.

In this case, three rows of pixel arrays, which are arranged within the monochrome shutter array 103 in correspondence to red, green and blue, respectively, are driven to permit only the light of the colors specified respectively to pass therethrough. For instance, when red linear light is irradiated, it can pass through only one pixel row corresponding to red, and the other two pixel rows are kept in a blocking state. Accordingly, the respective linear red, green and blue lights modulated by the monochrome shutter array 103 are focused on a photosensitive paper 105 such as the spectra instant film manufactured by Polaroid Inc., by means of a lens array 104. At this time, the respective red, green and blue linear lights are sequentially exposed to the photosensitive paper 105 at the same place thereof through a relative movement of the photosensitive paper 105 to the monochrome liquid crystal shutter array 103, so that a two-dimensional print image can be obtained.

With the conventional print head as described above, a photosensitive printing medium is exposed to light in the above manner to form a gradation or halftone image thereon. In order to attain a short printing time, for two above-mentioned kinds of liquid crystal shutters (i.e., the liquid crystal shutter 101 and the monochrome shutter array 103), there have generally been employed an STN (super twisted nematic) type liquid crystal, ferroelectric liquid crystal, etc., which can respond at high speed in the unit of milliseconds by applying thereto an AC voltage of 10 kHz or so.

On the other hand, Japanese Patent Laid-Open No. 62-134629 discloses that a light measuring portion is provided for measuring the quantity of light passing through a liquid crystal shutter so that adjustments are made to reduce a variation in density even in the case of a secular change (i.e., a change over time) in a light source of a print head. Specifically, the quantity of light of each color passing through the liquid crystal shutter is first measured by means of a photoelectric conversion light receiver when the liquid crystal shutter is placed in a transparent state in a predetermined time, and then the measured data thus obtained is integrated and converted from analog to digital form. Subsequently, image data is translated into a voltage application stop time of the liquid crystal shutter, which is then corrected according to the lights of respective colors.

Moreover, assuming that the quantity of exposed light is defined as the product of the light quantity and the exposure time, printing density generally exhibits a chromophore (color-generating) density characteristic in the form of an inverted S-shaped characteristic (i.e., in case the quantity of exposed light is taken in the abscissa and the printing density is taken in the ordinate). That is, the printing density shows a nonlinear characteristic with respect to the quantity of exposed light.

In the past, for the gradation data indicative of the density of image data, e.g., one having 256 levels of gradation, a value ranging from “0” to “255” is assigned and exposure is effected with the light source being set to a constant quantity of light per unit time; an exposure time of t0 is assigned to gradation data 0; an exposure time of t1 is assigned to gradation data 1; and an exposure time of t255 is assigned to gradation data 255. Upon printing the data of gradation data n, exposure is effected for a period of a total exposure time t which is expressed as follows:

$$t = {\sum }_{i = 0}^{n} t i$$

Therefore, if an exposure time ti assigned to each gradation is set constant (i.e., t0=t1=. . . =t255) for a photosensitive printing medium having a nonlinear printing density characteristic as referred to above, a change in the printing density with respect to a gradation change does not become constant, it is difficult to obtain good reproducibility in highlight portions and shadow portions. Thus, in cases where gradation is printed on a photosensitive printing medium, the nonlinear characteristics such as the printing density, brightness, etc., are adjusted through the quantity of exposed light for each gradation, so that the relation between gradation and density, the relation between gradation and brightness, etc., become substantially linear.

With the conventional optical printing apparatus as described above, there is a problem in that it is impossible to achieve high-quality printing at low cost. That is, the complicated construction including the light receiver can not avoid high cost, and it is difficult to effectively correct density variations resulting from variations in the component elements of the print head.

In addition, in the case where the nonlinear characteristics such as the printing density, brightness, etc., are adjusted through the quantity of exposed light for each gradation so as to make substantially linear the relation between gradation and density, the relation between gradation and brightness, etc., it is necessary to change the exposure time for each gradation if the quantity of exposure is constant. This results in another problem that calculations for such changed exposure times become difficult, or it is required to use a huge look-up table including an enormous amount of data.

### SUMMARY OF THE INVENTION

The present invention is intended to obviate the above-mentioned various problems, and has for its object to provide an optical printing apparatus which is low in cost, simple in construction and capable of forming an image of uniform density.

According to the present invention, there is provided an optical printing apparatus in which an image data indicative of a density of each of a plurality of pixels forming an image with a first gradation value is input, so that a plurality of exposure elements of a print head are each driven to perform an exposure with a required quantity of exposure light (i.e., product of a quantity of light and an exposure time), thereby forming a pixel corresponding to each of the exposure elements on a photosensitive printing medium which generates a color of a density corresponding to the required quantity of exposure light. The optical printing apparatus comprises: an exposure level conversion section for converting the image data into corresponding exposure level data indicative of a density of each pixel with a second gradation value greater than the first gradation value indicated by the image data, and for outputting the exposure level data thus converted; and a head driving section being connected to receive the exposure level data from the exposure level conversion section and driving, based on the exposure level data, each element of the print head to expose the photosensitive printing medium in such a manner that a quantity of light corresponding to the exposure level data is exposed to the photosensitive printing medium, thereby forming a pixel of a density corresponding to the exposure level data on the photosensitive printing medium.

In a preferred form of the present invention, the photosensitive printing medium has a nonlinear chromophore density characteristic in which the density of a color generated in accordance with a quantity of exposure light is nonlinear with respect to the quantity of exposure light, and the exposure level conversion section converts the image data into the exposure level data in such a manner that the density of a pixel formed on the photosensitive printing medium corresponding to the exposure level data is linear with respect to the image data corresponding to the exposure level data.

In another preferred form of the present invention, upon exposure of each element of the print head, the quantity of light per unit time of each element is constant, and the head driving section drives each element of the print head in such a manner that the exposure time of each element is proportional to the magnitude of the exposure level data.

In a further preferred form of the present invention, the exposure level conversion section includes an exposure level conversion table for correlating the image data and the exposure level data with respect to each other.

In a yet further preferred form of the present invention, the image data indicates the density of each of three primary colors for a plurality of pixels forming a color image with the first gradation value for each pixel. The exposure level conversion section converts the image data input thereto into corresponding exposure level data for each color which is indicative of the density of each color of each pixel represented by the image data with a second gradation value greater than the first gradation value for each color. The head driving section receives the exposure level data for each color and drives each element of the print head to expose the photosensitive printing medium in such a manner that a quantity of light corresponding to the exposure level data is exposed to the photosensitive printing medium, thereby forming a pixel of a density for each color corresponding to the exposure level data for each color on the photosensitive printing medium.

In a still further preferred form of the present invention, the optical printing apparatus further comprises an exposure level correction section for correcting exposure level data output from the exposure level conversion section by a correction factor for each element of the print head, and outputting a corrected exposure level. The head driving section receives the corrected exposure level and drives each element of the print head to expose the photosensitive printing medium in such a manner that a quantity of light corresponding to the input corrected exposure level is exposed to the photosensitive printing medium, thereby forming a pixel of a density corresponding to the corrected exposure level data on the photosensitive printing medium.

In a further preferred form of the present invention, the exposure level correction section comprises: a correction factor storing section for storing a correction factor for each element of the print head; a table describing corrected exposure level data while correlating each correction factor and exposure level data with respect to each other. The exposure level correction section determines corrected exposure level data from a correction factor read out from the correction factor storing section and an input exposure level data while referring to the table, and outputs the corrected exposure level data thus determined.

In a further preferred form of the present invention, the exposure level correction section comprises: a correction factor storing section for storing a correction factor for each element of the print head; and a multiplier for multiplying the correction factors and exposure level data. The exposure level correction section determines corrected exposure level data from a correction factor read out from the correction factor storing section and an input exposure level data, and outputs the corrected exposure level data thus determined.

In a further preferred form of the present invention, the optical printing apparatus further comprises: an accumulated exposure time information storing section for storing accumulated exposure time information corresponding to an accumulated exposure time of the print head; and an exposure level correcting section for correcting exposure level data output from the exposure level conversion section in accordance with accumulated exposure time information output from the accumulated exposure time information storing section, and for outputting the thus corrected exposure level data. The head driving section receives the corrected exposure level and drives each element of the print head to expose the photosensitive printing medium in such a manner that a quantity of light corresponding to the input corrected exposure level is exposed to the photosensitive printing medium, thereby forming a pixel of a density corresponding to the corrected exposure level data on the photosensitive printing medium.

The above and other objects, features and advantages of the present invention will become more readily apparent to those skilled in the art from the following detailed description of preferred embodiments of the invention taken in conjunction with the accompanying drawings.

### BRIEF DESCRIPTION OF THE DRAWINGS

FIG. 1 is a view illustrating the construction of an optical printing apparatus according to embodiments 1, 2 and 3 of the present invention.

FIG. 2 is a view illustrating an example in which of converting image data into exposure levels in the embodiments 1, 2 and 3 of the present invention.

FIG. 3 shows an exposure level conversion table in the embodiment 1 of the present invention.

FIG. 4 shows an exposure level correction table in the embodiments 1, 2 and 3 of the present invention.

FIG. 5 is a view illustrating examples of a printing density and a correction factor for respective elements in the embodiment 1 of the present invention.

FIG. 6 is a view illustrating the relation between the image data and the exposure level in the embodiments 1, 2 and 3 of the present invention.

FIG. 7 shows an exposure level conversion table in the embodiment 2 of the present invention.

FIG. 8 is a view illustrating the configuration of a correction factor storing section in the embodiment 3 of the present invention.

FIG. 9(a) is a view illustrating the configuration of an exposure level correction section in the embodiment 3 of the present invention.

FIG. 9(b) is a view illustrating a data correction section in the embodiment 3 of the present invention.

FIG. 10 is a view illustrating a modified form of the exposure level correction section in the embodiment 3 of the present invention.

FIG. 11 is a view illustrating another modified form of the exposure level correction section in the embodiment 3 of the present invention.

FIG. 12 is a view illustrating the construction of an optical printing apparatus according to embodiment 4 of the present invention.

FIG. 13 is a view illustrating the construction of an optical printing apparatus according to embodiment 5 of the present invention.

FIG. 14 is a view illustrating the relation between the accumulated exposure time and the quantity of light of a print head in the embodiment 5 of the present invention.

FIG. 15 is a view illustrating an exposure level correction section in the embodiment 5 of the present invention.

FIG. 16 shows an exposure level correction table in the embodiment 5 of the present invention.

FIG. 17 is a view showing a modified form of the exposure level correction section in the embodiment 5 of the present invention.

FIG. 18 is a view illustrating another modified form of the exposure level correction section in the embodiment 5 of the present invention.

FIG. 19 is a view illustrating the construction of a conventional optical printing apparatus.

### DESCRIPTION OF THE PREFERRED EMBODIMENTS

Now, preferred embodiments of the present invention will be described in detail while referring to the accompanying drawings. Embodiment 1.

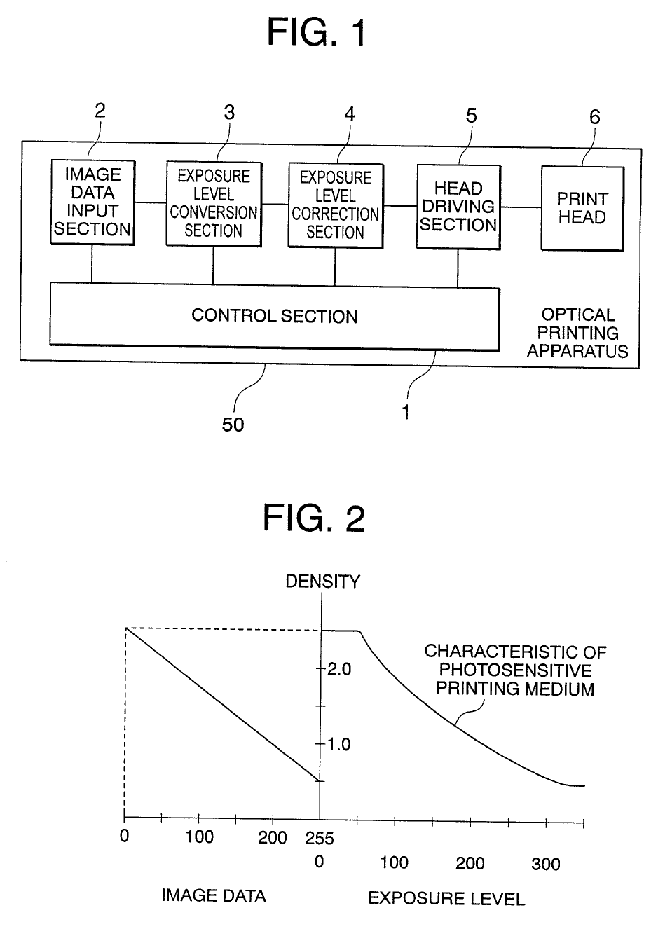

First, an embodiment 1 of the present invention will be described below with reference to FIG. 1 through FIG. 6.

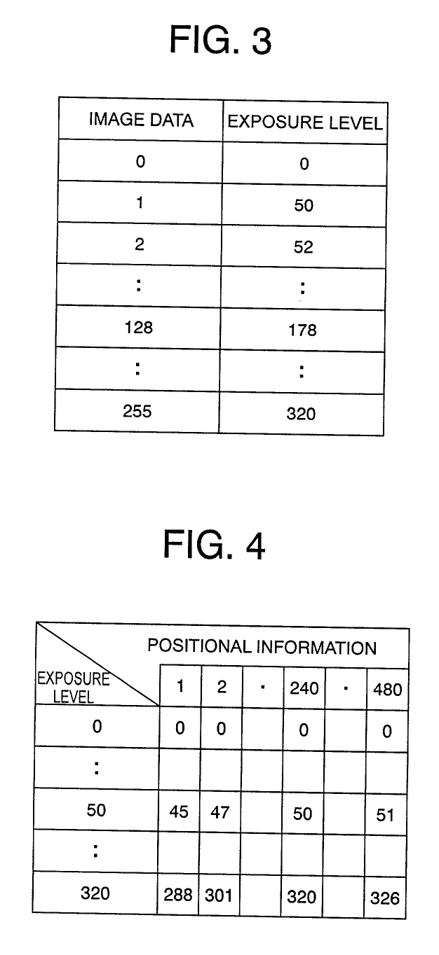

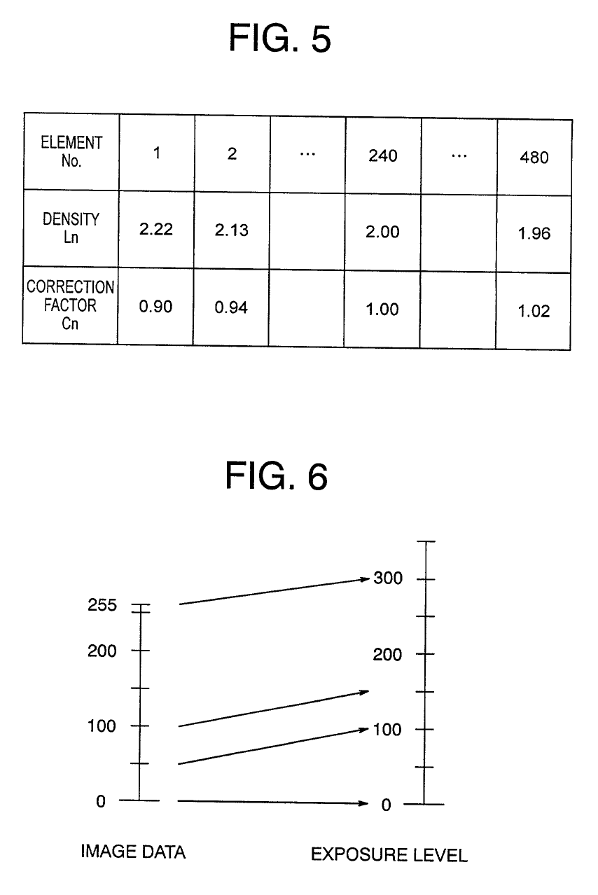

Referring to the drawings, FIG. 1 illustrates the construction of an optical printing apparatus according to this embodiment 1; FIG. 2 illustrates an example of converting image data into exposure levels; FIG. 3 shows an exposure level conversion table for correlating image data with exposure levels; FIG. 4 shows an exposure level correction table for correlating the exposure level for each element with an optimal exposure level; FIG. 5 illustrates an example of printing densities and correction factors; and FIG. 6 illustrates the relation between image data and exposure levels.

The above-mentioned term “exposure level” is synonymous with the term “exposure level data” in the present invention.

In FIG. 1, an optical printing apparatus, generally designated at reference numeral 50, includes a control section 1, an images data input section 2, an exposure level conversion section 3, an exposure level correction section 4, a head driving section 5, and a print head 6, all of them being described later in detail.

The control section 1 serves to control the respective component sections of the optical printing apparatus 50, and is composed of a microprocessor, electric circuits, and other elements such as a memory, etc., as required.

The image data input section 2 is to input image data to the control section 1, and includes an interface to which the image data is input, for example, from an external host computer, a portable terminal, etc., which are not shown, as gray-scale or gradation data for each pixel, and from which the input image data is output as the same gradation data to the control section 1. For such gradation data, a value ranging from 0 to 255 is input for the data of 256 gradations, a value ranging from 0 to 63 is input for the data of 64 gradations, and a value ranging from 0 to n-1 is input for the data of n gradations (i.e., n is an integer of 2 or more). Here, note that for physical interfaces, there can be used wired interfaces including existing Centronics-compatible parallel interfaces, serial interfaces such as RS 232 C interfaces, IEEE1394 interfaces, universal serial bus (USB) interfaces, etc., and wireless interfaces such as infrared (IR) communications interfaces, Bluetooth interfaces, etc. Communications of various sorts of data (e.g., the number of pixels, image data, etc.) between the unillustrated external host computer, etc., and the optical printing apparatus are carried out by means of the control section 1 according to desired procedures In this embodiment, it is assumed that the image data input to and output from the image data input section 2 is of 256 gradation steps and eight bits. In addition, this number of gradation steps is the first number of gradation steps in the present invention.

The exposure level conversion section 3 serves to convert the image data output from the image data input section 2 into a corresponding exposure level by means of a table format for instance.

In general, assuming that the quantity of exposure or exposed light is defined as the product of the quantity of light and the exposure time, the printing density of a photosensitive printing medium often shows an inverted S-shaped characteristic with respect to the exposure quantity (i.e., a characteristic where the quantity of exposure is taken in the abscissa and the printing density is taken in the ordinate). That is, the chromophore density (color generation density) of generating a color according to the quantity of exposure exhibits a nonlinear chromophore density characteristic with respect to the quantity of exposure. The exposure level conversion section 3 is constructed such that it converts the image data of eight bits into an exposure level for an exposure quantity adjusting data of nine bits higher in resolution than the image data in response to the characteristic of the photosensitive printing medium. The number of graduation steps at this exposure level is the second number of graduation steps in the present invention.

FIG. 2 shows an example of converting image data into exposure levels, and the conversion procedure is outlined as follows.

(1) A photosensitive printing medium is exposed with a constant quantity of light, and the relation between the exposed time A and the printing density of a specific element is obtained.

(2) The exposed time A is divided by a prescribed time T to provide an exposure level E, and the relation between the thus obtained exposure level A and the printing density is obtained. This relation is expressed by a curve B in FIG. 2 which represents the relation between the exposure level and the density in FIG. 2, the curve being dependent on the characteristic of the photosensitive printing medium.

(3) A maximum printing density and a minimum printing density printable on the printing medium are determined from processes (1) and (2) above.

(4) The printing density and the image data are correlated with each other in such a manner that the line between the maximum printing density and minimum printing density changes linearly. This relation is expressed by a straight line in FIG. 2 which represents the relation between the image data and the density.

(5) An exposure level to the image data is calculated from the relation of the density to the image data and the relation of the exposure level to the density in FIG. 2.

(6) From the result of process (5) above, an exposure level conversion table is prepared which correlates the image data with the exposure level, as shown in FIG. 3. This exposure level conversion table is written into and preserved in an unillustrated memory such as a PROM, etc., in the exposure level conversion section 3.

The above processes (1) through (6) are carried out by printing the data of various gradation steps onto the photosensitive printing medium prior to the shipment of the optical printing apparatus which has been assembled.

Moreover, the aforementioned prescribed time T is called a unit exposure time. Thus, an exposure level E means that exposure is performed for a period of E times the unit exposure time.

The exposure level correction section 4 corrects an exposure level output from the exposure level conversion section 3 in accordance with variations in the print head 6, etc., to be described later in detail.

There are a variety of causes of variations in the printing density, such as variations in the size of each component element of the print head 6 and in the wiring resistances, etc. Accordingly, the exposure level correction section 4 is composed, for example, of an exposure level correction table of the table format as shown in FIG. 4 in order that if the exposure level to each element is the same, the printing density becomes the same for each element 4. The exposure level correction section 4 receives the exposure level output from the exposure level conversion section 3 and the exposure position information of the print head 6 (i.e, information which indicates the position of the element being exposed), and corrects, based thereon, the exposure level to each element to an optimal exposure level. The exposure position information (i.e., positional information) is output from the control section 1.

For instance, as shown in FIG. 4, in the case where the correction factors of the first element, the second element, the 240th element and the 480th element (i.e., their positional information being 1, 2, 240 and 480, respectively) of the print head 6 are 0.9, 0.94, 1.0 and 1.02, respectively, when “50” is input to the exposure level correction section 4 as an exposure level, their exposure levels (corrected exposure levels) are corrected to 45, 47, 50 and 51, respectively.

Prior to the shipment of the optical printing apparatus which has been assembled, the exposure level correction table of FIG. 4 is created by printing the data of various sorts of gradation steps on a photosensitive printing medium, and written into and preserved in an unillustrated memory such as a PROM, etc., in the exposure level correction section 4.

Now, reference will be had to the creation of the exposure level correction table of FIG. 4.

(1) Exposures are performed for the same period of time for all the elements, and variation data Ln (n=1, 2, . . . , 480) showing the printing density for the respective elements are determined. Examples of such variation data are illustrated in FIG. 5.

(2) The average density of the respective elements is taken as a target correction value S. In the examples of FIG. 5, let us assume that the average density (=ΣLn/480) is 2, i.e., S=2.

At this time, a prescribed target correction value S may be used instead of the average density.

(3) A correction factor Cn (n=1, 2, . . . , 480) for the position of each element is determined. Here, the correction factor Cn is set as follows: Cn=S/Ln. This is shown in FIG. 5.

(4) The exposure level for the position of each element is multiplied by the correction factor Cn to provide a corrected exposure level, which is then correlated with the position information of each element to form a table as shown in FIG. 4.

Alternatively, such a table may be formed by using exposure levels obtained by experiments.

As a result, the actual printing density by means of each element becomes constant if the exposure level output from the exposure level conversion section 3 is the same.

The printing densities are determined in step (1) above, and the average of the printing densities is taken as the target correction value in step (2) above, but in the case where the print head 6 is composed of light emitting elements such as LEDs, ELs, etc., the quantity of light of each element may be used in place of the printing density. In this case, it is not necessary to actually print on a photosensitive printing medium.

Moreover, though the average density of the respective elements is used as the target correction value in step (2) above, a minimum density and a maximum density may instead be employed. Also, in the case of the light emitting elements, there may be used a minimum quantity of light and a maximum quantity of light.

The head driving section 5 serves to generate the corrected exposure level output from the exposure level correction section 4 as head driving data. For instance, in the case where the print head 6 is a binary print head, only binary data of a print and a non-print can be input to the print head 6, and hence binary data is transmitted to the print head 6 according to the exposure level so that exposure is carried out for the unit exposure time for each binary data. For instance, when the exposure level is of the maximum value of 326, data transmissions are effected 326 times and exposures are also performed 326 times. As a consequence, the exposure time of each element of the print head 6 becomes proportional to the magnitude of the exposure level.

On the other hand, in the case where the print head 6 is of the multi-value type, the output data of the exposure level correction section 4 is directly transmitted to the print head 6 without any change.

In either of the above cases, the head driving section 5 controls the interface to the print head 6, for example, clock signals, latch signals, etc., in accordance with the timing of the print head 6. As a method for driving the print head 6, the print head 6 is driven to operate in such a manner that exposures are effected one for each unit exposure time (e.g., a fixed value of 1 μs-300 μs or so) at times corresponding to the exposure level, and the density of each pixel formed on the photosensitive printing medium becomes linear with respect to the image data corresponding to the exposure level.

For the print head 6, there can be used self chromophore type elements (i.e., self color-generating elements) such as LEDs, ELs, etc., or light source control type elements equipped with liquid crystal shutter elements. For instance, in the latter case, 640 liquid crystal shutter elements are arranged in a line, and driven to operate so that light from an unillustrated light source can selectively pass therethrough to form an image while controlling the transparent or light-passing time thereof.

For instance, the liquid crystal shutter elements comprises two glass plates with a liquid crystal of TN (twist nematic) type sealingly enclosed therebetween. In this liquid crystal shutter, two polarizing plates are arranged outside of the two glass plates, respectively, with their absorption axes being shifted by 90 degrees with respect to each other. With this arrangement, light can pass or penetrate through the liquid crystal shutter elements (i.e., a state of penetration) when a voltage is not applied to them, but light is intercepted and can not pass therethrough (i.e., a state of interception) upon application of a voltage thereto. Thus, the penetration/interception of light can be controlled by adjusting the period of time during which a voltage is imposed on the liquid crystal shutter, as a result of which the exposure time can be properly controlled so as to form an image with a tone or gradation. This arrangement is called a positive type liquid crystal shutter element construction. On the other hand, the construction of the liquid crystal shutter elements of the negative type indicates such a construction that two polarizing plates are arranged with their absorption axes being disposed in a parallel relation with respect to each other, so that light is intercepted and can not pass the liquid crystal shutter elements (i.e., the state of interception) when no voltage is applied to them, whereas light can pass or penetrate therethrough (i.e., the state of penetration) upon application of a voltage thereto. In this manner, a gradation image can be formed by controlling the voltage application time. However, the liquid crystal shutter elements of the positive type is relatively large in the light transmittance in the state of interception as compared with the negative type, and hence has low contrast and poor gradation. Therefore, the positive type is desirable for the print head 6.

Moreover, there are various kinds of liquid crystals, including nematic liquid crystals of the TN type, the STN type, etc., cholesteric liquid crystals, or smectic liquid crystals represented by ferroelectric liquid crystals. The desired characteristics of the print head 6 mounted on an optical printing apparatus are as follows: the contrast ratio is high; the response speed of each liquid crystal shutter element is high; the driving voltage is low; and the shock resistance is stable, etc. As a result of comprehensive evaluations of these items, it was experimentally concluded that the TN type liquid crystals are most preferable for the print head 6. For instance, the TN type liquid crystals were not less than ten times more excellent in the contrast ratio than the STN type liquid crystals, and the TN type liquid crystals were more stable in the shock resistance than the smectic liquid crystals.

Therefore, it was found that the TN-type liquid crystals of the positive type were the best.

Next, the operation of this embodiment 1 will be described below while referring to FIG. 1. First of all, the image data input to the image data input section 2 is converted into a corresponding exposure level by the exposure level conversion section 3. The image data is sequentially converted into the exposure level by using the table shown in FIG. 3 or like other method. More specifically, the exposure level conversion section 3 is composed of a memory or the like, to which image data is input as an address, thereby providing a desired exposure level. An exposure level output from the exposure level conversion section 3 is corrected by the exposure level correction section 4 according to variations in the print head 6, etc. Specifically, the exposure level correction section 4 is configured as a table shown in FIG. 4, and corrects the exposure level input thereto from the exposure level conversion section 3 to a suitable amended exposure level based on the positional information generated by the control section 1. Thereafter, the corrected exposure level is forwarded to the print head 6 through the head driving section 5, so that the print head 6 forms a gradation image.

Upon formation of the image, an exposure of the unit exposure time T is repeated Ec times while maintaining the quantity of light at a constant value and setting the corrected exposure level to Ec, whereby an image with a density corresponding to the image data is obtained.

As described above, according to this embodiment 1, the optical printing apparatus is constructed such that image data is converted into an exposure level in accordance with the characteristics of the print head 6 and the photosensitive printing medium, and the exposure level is further corrected in view of unevenness in the density resulting from the print head 6. Such a construction is advantageous in that a high-quality printed image can be obtained.

Moreover, since it is constructed such that image data is converted into an exposure level in accordance with the characteristic of the print head 6 and the photosensitive printing medium, there is obtained an advantage that a high-quality printed image is obtained.

Further, since it is constructed such that the exposure level is corrected in view of unevenness in the density resulting from the print head 6, there is obtained an advantage that a high-quality printed image is obtained.

Here, it is to be noted that in this embodiment 1, various changes or combinations can be made without departing from the purport of the present invention. For instance, in order to shorten the data transmission time with an external host computer, an image data storage device may be provided for storing a prescribed amount of image data (e.g., image data for one line, or one screen or frame, etc.).

In addition, although in the embodiment 1, exposures are carried out at a number of times corresponding to each exposure level so that the relation between the printing density and the gradation characteristic becomes linear, the exposure time may instead or additionally be controlled to make linear the relation between the lightness or brightness and the gradation characteristic. Further, the exposure level conversion section 3 may not be of a table format, but it may instead be constructed in such a manner that image data can be converted into a corresponding exposure level through calculations of the control section 1. Thus, the exposure level conversion section 3 is not specifically limited in its form.

Additionally, it may be constructed such that the content of the table of the exposure level correction section 4 can be exchanged upon replacement of the print head 6 or in case of deterioration thereof due to a secular change or the like, or the content of the table can be downloaded from the outside as required. Besides, though the correction factor has been calculated from the average density, it may be calculated from an absolute desired density so as reduce variations among apparatuses.

Furthermore, preferably, the exposure level conversion section performs conversion in such a manner that the relation between the maximum value of the exposure level and the maximum value of the image data becomes as follows:

maximum value of the exposure level ≧maximum value of the image data.

This is because it is possible to make the gradation characteristic more excellent (i.e., more accurate) as shown in FIG. 6. The larger the maximum value of the exposure level, the higher the quality of image printing becomes. In this regard, it is desirable to determine the maximum value of the exposure level based on a comprehensive judgement of the characteristic of human eyes, the printing speed, the cost of the apparatus and the image quality.

Still further, although in the embodiment 1, it is constructed such that the exposure level correction section 4 is provided for correcting variations in the component elements of the print head 6, the exposure level correction section 4 may not be required in the case where such variations in the print head elements are too limited to affect the printed image. In this case, since image data is converted into a corresponding exposure level in accordance with the characteristics of the print head 6 and the photosensitive printing medium, there is provided an advantage that a high-quality printing image can be obtained. Also, another advantage is achieved that the optical printing apparatus can be simplified in construction and hence manufactured at low cost. In this case, too, it is preferable that the maximum value of the exposure level be greater than the maximum value of the image data.

Embodiment 2.

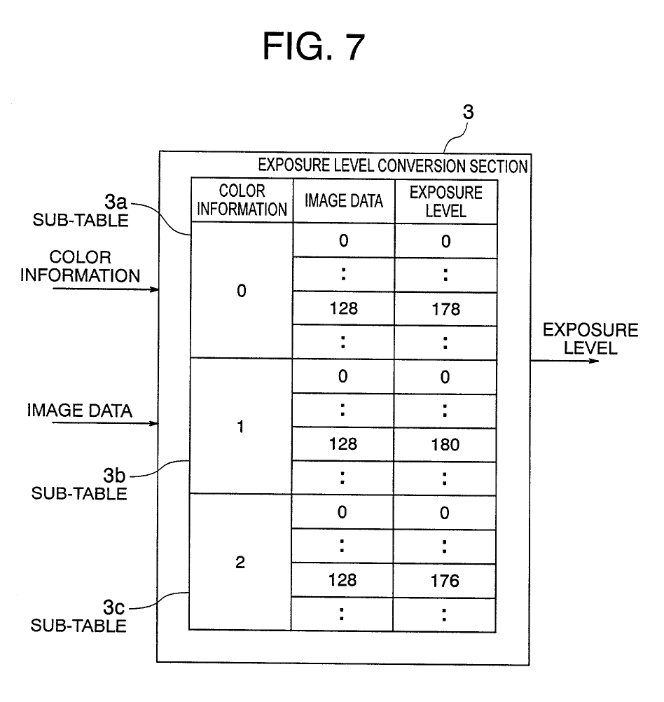

Now, an embodiment 2 of the present invention will be described below while referring to FIG. 1 and FIG. 7.

Although in the embodiment 1, there has been illustrated an example in which the input to the exposure level conversion table is image data alone, this embodiment 2 discloses another example in which the input to the exposure level conversion table includes image data and color information corresponding to the image data.

The optical printing apparatus of this embodiment 2 is substantially similar in construction in that of the embodiment 1 illustrated in FIG. 1 except for the exposure level conversion section 3. That is, the exposure level conversion section 3 of the embodiment 2 includes a different exposure level conversion table as shown in FIG. 7.

In this embodiment 2, the image data which is input to or output from the image data input section 2 of FIG. 1 is a color image data related to a color image comprising three primary colors including red (R), green (G) and blue (B). The color image data comprises gradation data representative of the gradation of each of the three primary colors, and such gradation data related to the three primary colors is sequentially transmitted for each pixel. Also, color information indicative of which color the image data input to the exposure level conversion section 3 relates to is input to the exposure level conversion section 3 from the control section 1.

FIG. 7 shows the exposure level conversion table included in the exposure level conversion section 3 in FIG. 1. This exposure level conversion table is composed of a plurality of sub-tables 3a, 3b and 3c corresponding to three primary colors. In the sub-tables, color information Nos. 0, 1 and 2 represent red, green, and blue, respectively. Concretely, the exposure level conversion section 3 converts the image data output from the image data input section 2 into a corresponding exposure level while taking into consideration the color information from the control section 1, and then outputs the thus converted exposure level to the image data correction section 4.

The creation of the exposure level conversion table of FIG. 7 is performed by creating an exposure level conversion table of FIG. 3, as referred to in the embodiment 1, for each color in accordance with the following procedural steps (1) and (2).

(1) The relation between the image data and the exposure level as illustrated in FIG. 2 and described in the embodiment 1 is determined for each color.

(2) Color information is added to the relation between the image data and the exposure level for each color as determined in step (1) above, thus preparing an exposure level conversion table as shown in FIG. 6. This exposure level conversion table is written into and preserved in an unillustrated memory such as a PROM, etc., in the exposure level conversion section 3, and preserved.

In this embodiment 2, an exposure level E means that exposures are performed for a period E times the prescribed unit exposure time T as in the embodiment 1.

Moreover, this exposure level conversion table is created by printing data of various sorts of gradations for each color onto the photosensitive printing medium prior to the shipment of the optical printing apparatus which has been assembled, as in the embodiment 1.

Next, the operation of this embodiment 2 will be described.

A series of color image data (R, G, B) for forming a color image composed of three primary colors are input to the image data input section 2 as eight-bit or 256-value data (“0”-“255”) for example, and then sequentially input therefrom to the exposure level conversion section 3. As shown in FIG. 7, the exposure level conversion section 3 is constructed such that it includes an exposure level conversion table composed of a memory or storage device such as a PROM, etc., and outputs an exposure level with its related color image data and color information from the control section 1 as its addresses. More specifically, the exposure level conversion section 3 assigns “0” to R color information, “1” to G color information, and “2” to B color information, and outputs, together with this color information, a table value (i.e., exposure level) corresponding to the color image data input thereto. For example, as shown in FIG. 7, color image data (R) of “128” is converted into an exposure level of “178”; color image data (G) of “128” is converted into an exposure level of “180”; and color image data (B) of “128” is converted into an exposure level of “176”, respectively.

The exposure level output from the exposure level conversion section 3 is corrected in terms of variations in the component elements of the print head 6 and the like by means of the exposure level correction section 4 as in the embodiment 1. Thereafter, the head driving section 5 carries out data transfer to the print head 6 a number of times corresponding to the corrected exposure level for each color. Then, a color gradation image is formed with the exposure by the print head 6 in response to the data transfer from the head driving section 5.

As described above, according to this embodiment 2, since image data is converted into an exposure level according to the color information corresponding to the image data, there is obtained the following advantage. That is, the printing of a color image with higher quality can be obtained for a photosensitive printing medium that has exposure characteristics different for each exposure color, and hence it is possible to make image formation with a good color balance.

Further, in this embodiment 2, since the exposure level can be changed delicately or finely in response to an individual color image, there is obtained an advantage that the printing of a high-quality image can be made with a good color balance.

Here, note that in this embodiment 2, various changes or modifications can be made, and thus an unillustrated color image data storage device may be provided for storing color image data, similar to the various changes or modifications as described in the embodiment 1. Moreover, for such color image data, there may be used the data corresponding to yellow, magenta and cyanogen. Also, spectral data may be employed such as a combination of R, G, B with yellow, magenta and cyanogen. In addition, though the exposure level conversion section 3 includes a plurality of tables, such tables, if having similar characteristics, can be reduced while using a limited number of tables in common (e.g., a common table is used for R and B so as to reduce the number of tables employed). Further, the exposure level conversion section 3 may be constructed such that it may not simply use a plurality of tables but have only the feature portions of the tables (i.e., make the tables compact) and use them in combination with calculations to achieve the same effect, and hence there is no particular limitations in this respect. Additionally, the tables may be formularized in such a manner that image data and color information as inputs are converted into an exposure level.

Further, a construction or mechanism may be added for reducing or eliminating density variations due to a change in the environmental temperature, humidity, etc. For instance, (1) a temperature detector may be provided in the neighborhood of the print head 6 or inside the optical printing apparatus for detecting the environmental temperature or the temperature of the print head 7 itself; (2) the result of the temperature detection is input to the exposure level conversion section 3; and (3) the exposure level can be adjusted or corrected according to the characteristic of the temperature in addition to the image data and color information. In this manner, a printing apparatus capable of printing a high-quality image irrespective of the temperature can be achieved.

Embodiment 3.

An embodiment 3 of the present invention will be described below while referring FIG. 1 and FIG. 8 through FIG. 11.

Although in the embodiment 1, there has been shown and described an example in which a corrected exposure level is determined from an exposure level and positional information by using an exposure level correction table shown in FIG. 4, this embodiment 3 discloses a further example in which a correction factor for each component element of the print head 6 is determined from positional information, and a corrected exposure level is calculated from the thus determined correction factor and an exposure level.

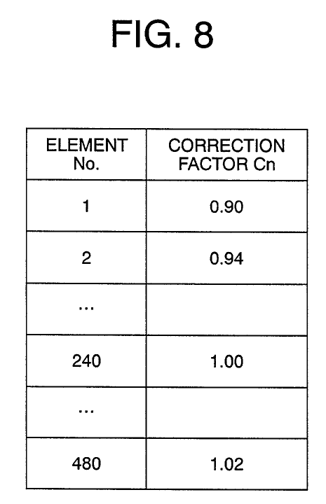

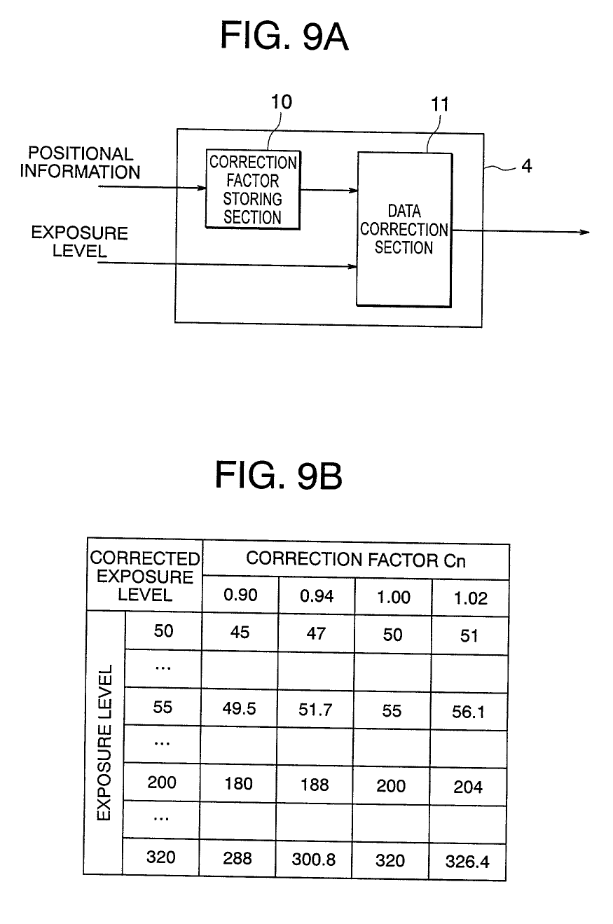

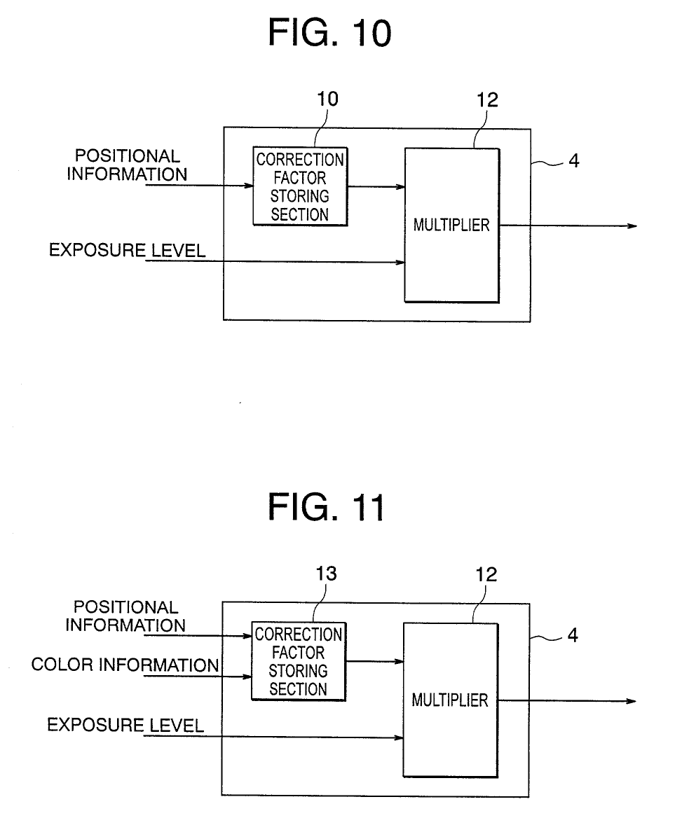

An optical printing apparatus of this embodiment 3 is substantially similar in construction in that of the embodiment 1 illustrated in FIG. 1 except for the exposure level correction section 4. That is, the exposure level correction section 4 of the embodiment 3 includes a correction factor storing section as shown in FIG. 8. FIGS. 9(a) and 9(b) illustrate the configuration of the exposure level correction section 4 and a data correction section, respectively, of this embodiment 3. FIG. 10 and FIG. 11 illustrate modified forms or other examples of the exposure level correction section 4 in this embodiment 3.

In this embodiment 3, the exposure level correction section 4 of FIG. 1 is different in configuration from that of the embodiment 1, but the construction of this embodiment 3 other than the exposure level correction section 4 is the same as that of the embodiment 1.

FIG. 8 shows the configuration of the correction factor storing section 10 in this embodiment 3, which takes a table format in which a correction factor Cn is correlated with the positional information of each component element of the print head 6. This correction factor storing section 10 includes the relation between the element numbers and the corresponding correction factors as shown in FIG. 5 determined in the process of creating the exposure level correction table of FIG. 4 as explained in the embodiment 1, and this relation is written into a storage device such as a PROM or the like.

FIG. 9(a) illustrates the construction of the exposure level correction section 4 of this embodiment 3, which includes the correction factor storing section 10 as referred to in FIG. 8, and a data correction section 11. The data correction section 11 is of a table format for determining a corrected exposure level from a correction factor and an exposure level, as shown in FIG. 9(b). The corrected exposure level is the product of the correction factor and the exposure level.

When positional information from the control section 1 is input to the correction factor storing section 10, a correction factor corresponding to the positional information is output from the correction factor storing section 10 to the data correction section 11, which then determines a corrected exposure level based on the correction factor and an exposure level output from the exposure level conversion section 3, and outputs it to the head driving section 5.

The corrected exposure level is forwarded from the head driving section 5 to the print head 6, where a gradation image is formed similar to the explanation of the embodiment 1.

In this embodiment 3, if the axis of the correction factor in the data correction section 11 is assumed to represent the correction factors alone stored in the correction factor storing section 10, and the axis of the exposure level is assumed to represent the exposure levels alone stored in the exposure level conversion table of FIG. 3, the capacity of the data correction section 11 can be small.

In addition, if the axis of the correction factor in the data correction section 11 is graduated, for example, at intervals of 0.01 in the range from 0.07 to 1.3, and the axis of the exposure level is graduated at intervals of 1 in the range from 0 to 350, the capacity of the data correction section 11 becomes large but the correction factor storing section 10 need only be rewritten so as to adapt to a print head having any characteristic.

Further, the data correction section 11 of FIGS. 9(a) and 9(b) may be replaced with a multiplier 12 as shown in FIG. 10. The multiplier 12 calculates the product of the correction factor output from the correction factor storing section 10 and the exposure level input from the exposure level conversion section 3 according to the positional information input from the control section 1, and outputs it as a corrected exposure level. For instance, in the case where the exposure level is “128” and the correction factor is “0.94”, the multiplier 12 outputs the product “120” of “128” and “0.94” as the corrected exposure level.

The corrected exposure level is forwarded to the print head 6 through the head driving section 5, which forms a gradation image as described in the embodiment 1.

In this example, since the multiplier 12 is used for the exposure level correction section 4 to calculate the corrected exposure level, there is obtained an advantage that high-quality image printing can be achieved with an inexpensive construction.

Furthermore, as shown in FIG. 11, in addition to the brightness information on the print head 6, the color information input from the control section 1 may be utilized to provide a correction factor for each color to be exposed, thereby further improving the quality of the color image printed. This is based on the experimental result that correcting the unevenness in desity for each color can provide a color image of higher quality because of the presence of variations in the characteristics of a photosensitive printing medium for respective colors. In this case, the correction factor storing section 13 may be configured such that it includes a plurality of exposure level correction tables corresponding to the respective colors, as shown in FIG. 4. The exposure correction tables of such a case may be created by performing, for each color, the aforementioned procedure as described with reference to the creation of an exposure level correction table of FIG. 4 in the embodiment 1.

In addition, the decimal values are used as variation data in the above example, but integers corresponding to decimal values or normalized integers may instead be employed, and variation data is not limited to decimal values. Using integers provides merits in the circuit scale or the device cost.

Embodiment 4.

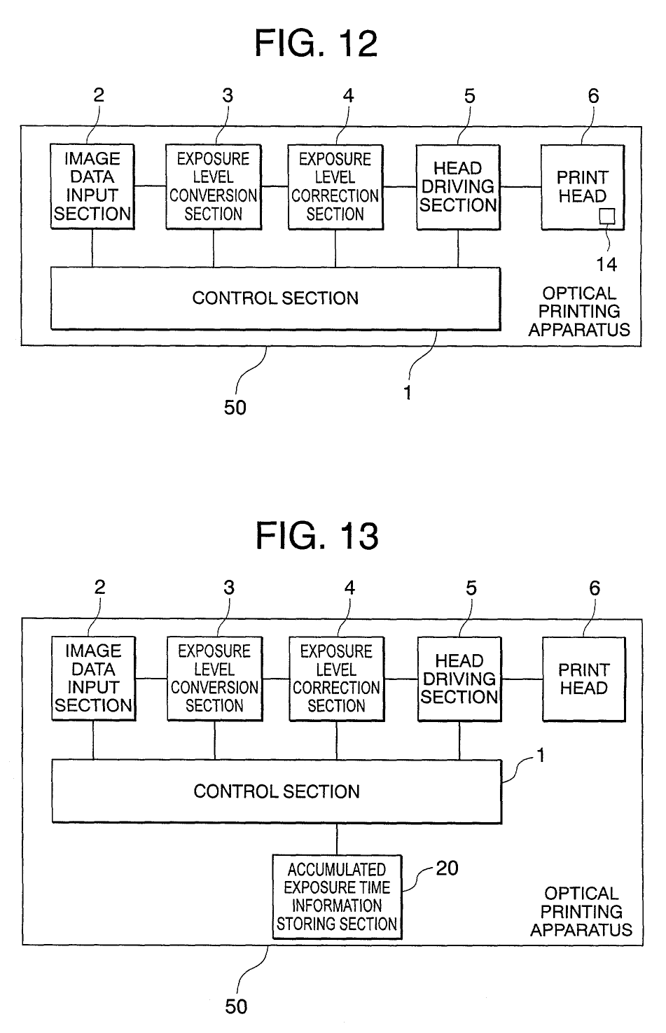

An embodiment 4 of the present invention will now be described while referring to FIG. 4 and FIG. 12.

Although in the embodiment 1, the exposure level correction table is included in the exposure level correction section 4, this embodiment 4 discloses an example in which an exposure level correction table is stored in a table storing section 14 of the print head.

In this embodiment 4, the exposure level correction table stored in the table storing section is the same as that of FIG. 4 described in the embodiment 1. FIG. 12 illustrates the construction of an optical printing apparatus of this embodiment 4, which is substantially the same as that of the embodiment 1 but different therefrom in that the table storing section 14 is included in the print head 6. Thus, the other portions of this embodiment 4 that are the same as those of FIG. 1 are identified at the same symbols while omitting an explanation thereof.

The table storing section 14 includes an exposure level correction table as described in the embodiment 1 with reference to FIG. 4.

First of all, when the optical printing apparatus is tuned on, the respective sections thereof are initialized and the exposure level correction table stored the table storing section 14 is transmitted therefrom to the exposure level correction section 4 via the control section 1. The exposure level correction table is developed in a manner as shown in FIG. 4 in the exposure level correction section 4. Subsequently, the image data input to the image data input section 2 is converted into a corresponding exposure level by means of the exposure level conversion section 3. The exposure level thus obtained is corrected together with the position information output from the control section 1 by means of the exposure level correction section 4. Then, the thus corrected exposure level is forwarded to the print head 6 through the head driving section 5, so that a gradation image is formed by the print head 6.

Here, note that the correction factor may be the data which is calculated by normalizing the rates of change (0.9 times, 0.94 times, . . . , etc) corresponding to the position information (1st, 2nd, . . . , etc.) for example.

As described above, according to this embodiment 4, since it is ensured that a proper combination of the print head 6 and a correction factor is achieved, there can be obtained an advantage that high-quality image printing is achieved at low cost.

Moreover, a further advantage is obtained that it is not necessary to correct or adjust the exposure level correction section upon replacement of the print head.

In this embodiment 4, various changes or modifications may be made as described in the embodiments 1 through 3. For instance, a construction or mechanism may be added for reducing or eliminating density variations due to a change in the environmental temperature, etc.

Embodiment 5.

An embodiment 5 of the present invention will now be described while referring to FIG. 13 through FIG. 18.

This embodiment 5 is to reduce density variations with an inexpensive construction even when the quantity of light is varied due to a secular change of the print head.

FIG. 13 illustrates the construction of an optical printing apparatus according to this embodiment 5, which is provided with an accumulated exposure time information storing section 20 for accumulating the exposure time of the print head 6 and storing therein the accumulated exposure time. In this figure, the configuration of the exposure level correction section 4 of this embodiment 5 is different from that of the embodiment 1, as shown in FIG. 15 and FIG. 16 to be described later in detail. The remaining portions of this embodiment 5 other than this are substantially similar to those shown in FIG. 1 of the embodiment 1.

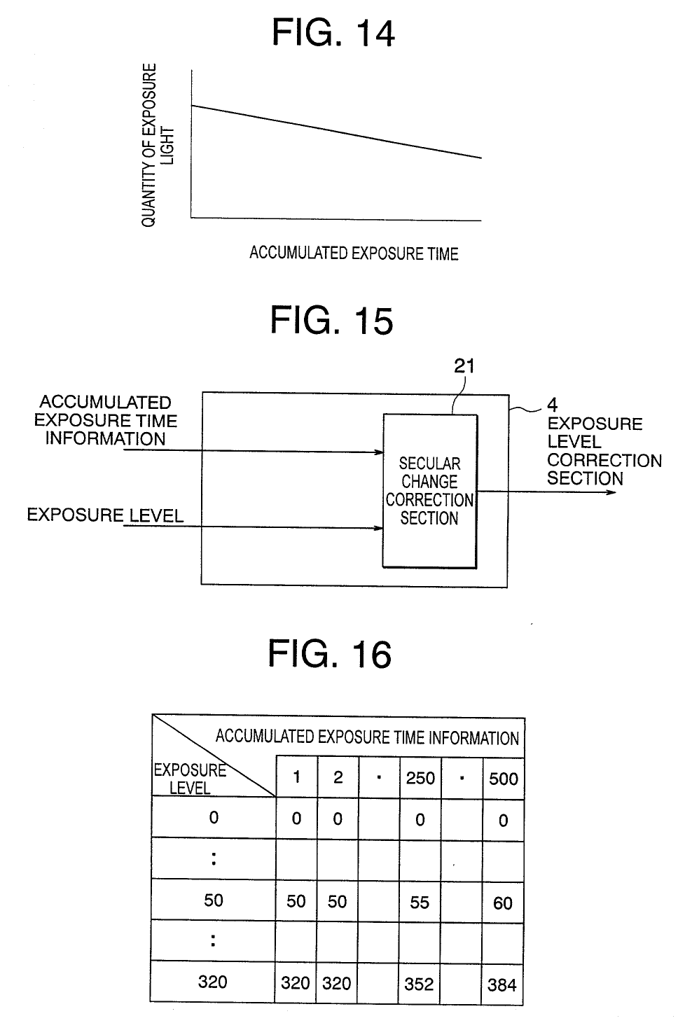

FIG. 14 shows the relation between the accumulated exposure time and the quantity of light of the print head. In general, the quantity of light of the print head 6 decreases due to a secular change in the light source and the like even if the same head driving data is input from the head driving section 5 to the print head 6. Such characteristics of the print head 6 varies depending on the construction, materials, the driving method, etc., thereof but the characteristics can be grasped beforehand (i.e., prior to shipment of the product).

FIG. 15 shows an exposure level correction section 4 of this embodiment 5. This exposure level correction section 4 includes a secular change correction section 21 which has an exposure level conversion table written into a memory such as a PROM, etc., as shown in FIG. 16. The secular change correction section 21 receives the accumulated exposure time information output from the accumulated exposure time information storing section 20 and the exposure level output from the exposure level conversion section 3, and corrects, based thereon, the exposure level in accordance with the condition of the secular change of the print head 6. Specifically, as shown in FIG. 16, the exposure level of “50” is corrected to “55” when the accumulated exposure time is 250 hours, and to “60” when the accumulated exposure time is 500 hours, according to the accumulated exposure time.

The accumulated exposure time information storing section 20 comprises a time counter, an adder and a nonvolatile memory, and operates to write an accumulated sum of respective head driving times from the time of manufacture of the optical printing apparatus into the nonvolatile memory. Specifically, the time counter acquires from the control section 1 the information about the fact that the head driving section 5 is driving the print head 6, and measures the head driving time based on this information. Each time the printing of one line or one screen or frame is completed, the accumulated exposure time information currently read out from the nonvolatile memory and the time which the time counter has currently measured are added to each other by means of the adder, and the sum is then written into the nonvolatile memory as new accumulated exposure time information. Instead, each time the printing of a plurality of lines or a plurality of screens or frames is completed, the accumulated exposure time information may be written into the nonvolatile memory.

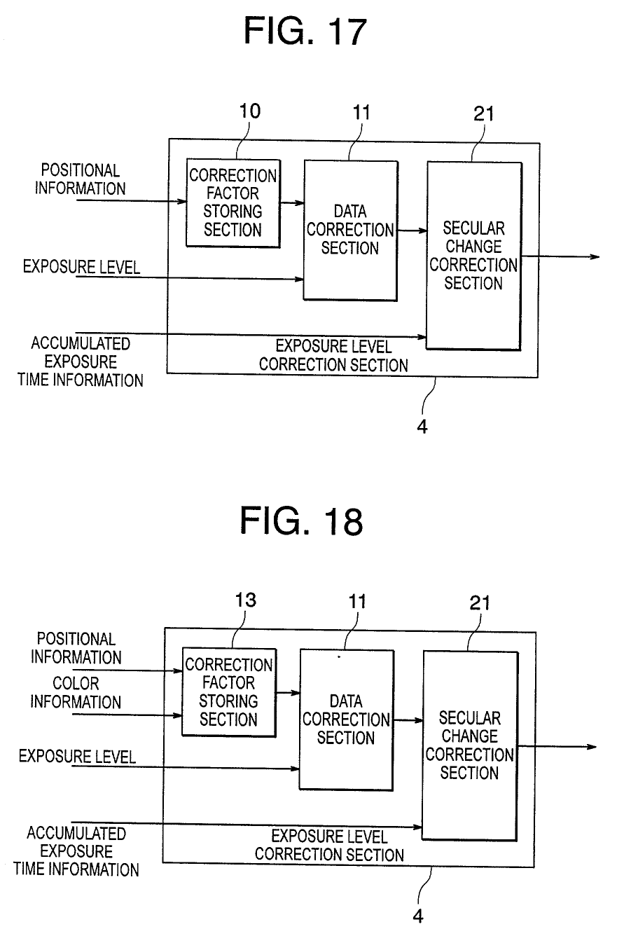

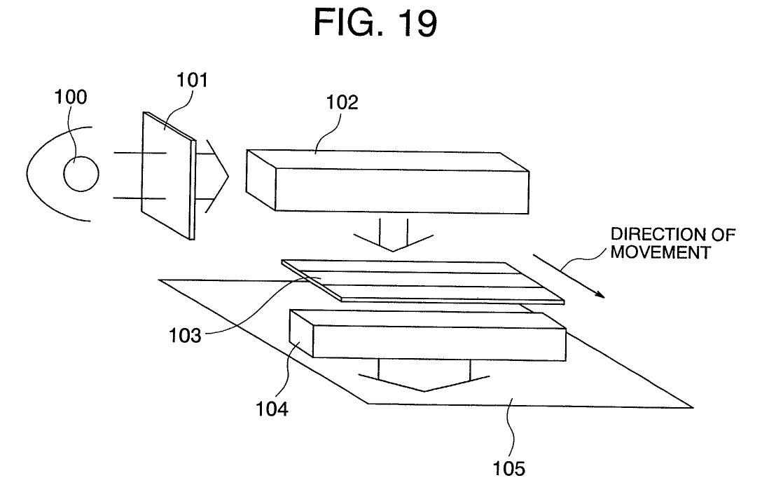

FIG. 17 and FIG. 18 illustrate modified configurations of the exposure level correction section of this embodiment, respectively.

The operations of these modified exposure level correction section will be described below.

First of all, for the purpose of preparations, the characteristic of the print head as shown in FIG. 14 is grasped in advance through appropriate means such as experiments, calculations, etc., and a table representing the relation between the exposure level and the accumulated exposure time information as shown in FIG. 16 is prepared based on this characteristic. Then, the image data input to the image data input section 2 is converted into a corresponding exposure level by the exposure level conversion section 3. The conversion of the image data into the exposure level is sequentially carried out according to a table method as shown in FIG. 3 or the like. Subsequently, the exposure level output from the exposure level conversion section 3 is corrected or adjusted by means of the exposure level correction section 4 in terms of the secular change, etc., in the print head 6. Specifically, the exposure level correction section 4 is configured in the form of a table as shown in FIG. 16, and receives the accumulated exposure time information, which is read out from the accumulated exposure time information storing section 20 by the control section 1, and the exposure level, and corrects the exposure level to a proper exposure level based on the accumulated exposure time information. Thereafter, the thus corrected exposure level is transmitted through the head driving section 5 to the print head 6, which forms a gradation image.

Here, note that the writing of the accumulated exposure time information into the accumulated exposure time information storing section 20 is effected by the control section 1 according to the time for which the print head 6 is exposed. The time of writing is not limited but may be anytime, e.g., after completion of the printing of one line or one screen or the like. However, the accumulated exposure time information storing section 20 must be a nonvolatile storage device such as a nonvolatile memory, etc.

As described above, since the embodiment 5 includes the accumulated exposure time information storing section 20, and corrects the exposure level based on at least the accumulated exposure time information stored therein, there is obtained an advantage that even if the print head is subjected to a secular change, high-quality image printing can be achieved.

In the above description related to the embodiment 5, no reference is made to the exposure level correction table (FIG. 4) included in the exposure level correction section 4, which has been described in the embodiment 1, but with the embodiment 5, such an exposure level correction table may also be included in the exposure level correction section 4 so that the exposure level output from the exposure level conversion section 3 can be corrected by referring to the positional information output from the control section 1 and the exposure level correction table, and then the thus corrected exposure level is input to the secular change correction section 21. With this arrangement, it is possible to correct variations in the respective component elements of the print head.

In addition, the exposure level correction table may be omitted or may not be used.

Moreover, the exposure level correction section 4 may be configured as shown in FIG. 17. That is, the exposure level correction section 4 may include a correction factor storing section 10 and a data correction section 11 as described in the embodiment 3 with reference to FIG. 8 and FIGS. 9(a) and 9(b), the output of the data correction section 11 being input to the secular change correction section 21. With such an arrangement, variations in the respective component elements of the print head can be corrected.

In addition, a multiplier as shown in FIG. 11 may be employed in place of the data correction section 11.

Further, in the embodiment 5, there has been described an example in which the accumulated exposure time information storing section 20 comprises a time counter, an adder and a nonvolatile memory, and operates to write into the nonvolatile memory the sum of the accumulated exposure time information and the time currently measured by the time counter, calculated by the adder, as new accumulated exposure time information. However, such a sum may be carried out by the control section 1 in place of the adder.

Furthermore, as illustrated in FIG. 18, if color information in addition to the positional information is input to the correction factor storing section 13 as described in relation to FIG. 11, there is obtained an advantage that unevenness in density of each color can be corrected, thus providing an image of high quality.

Still further, in the embodiment 5, there has been described an example in which the accumulated exposure time information storing section 20 is provided for storing the information on the accumulated exposure time of the print head, based on which the exposure level is corrected. Instead of this arrangement, however, there may be provided an accumulated printed sheet counter which is operatively connected with an unillustrated printing medium transmission mechanism for counting the accumulated number of sheets of printing medium, and a correction table having the exposure level corresponding to the accumulated number of sheets thus counted may be prepared and used in place of the correction table of FIG. 16.

Moreover, an accumulated printed line counter may be provided for counting the number of lines printed, and a correction table having the exposure level corresponding to the accumulated number of printed lines thus counted may be prepared and used in place of the exposure level correction table of FIG. 16.

In addition, upon counting the number of printed lines, the ratio of the number of the pixels actually printed to the total number of pixels in each line (printed ratio) may be calculated by the control section 1. That is, if the print ratio for a line is 80%, it is counted as 0.8 line. As a result, it is possible to reflect a secular change of the print head on the exposure level more accurately.

Thus, various sorts of items related to the accumulated exposure time of the print head may be adopted in place of the accumulated exposure time information of the exposure level correction table as shown in FIG. 16. The accumulated number of printed sheets and the accumulated number of printed lines as referred to above correspond to the accumulated exposure time information in the present invention. Also, the accumulated printed sheet counter and the accumulated printed line counter correspond to the accumulated exposure time information storing section in the present invention.

As described in the foregoing, in an optical printing apparatus according to the present invention, an image data indicative of a density of each of a plurality of pixels forming an image with a first gradation value is input, so that a plurality of exposure elements of a print head are each driven to perform an exposure with a required quantity of exposure light (i.e., product of a quantity of light and an exposure time), thereby forming a pixel corresponding to each of the exposure elements on a photosensitive printing medium which generates a color of a density corresponding to the required quantity of exposure light. The optical printing apparatus includes: an exposure level conversion section for converting the image data into corresponding exposure level data indicative of a density of each pixel with a second gradation value greater than the first gradation value indicated by the image data, and for outputting the exposure level data thus converted; and a head driving section being connected to receive the exposure level data from the exposure level conversion section and driving, based on the exposure level data, each element of the print head to expose the photosensitive printing medium in such a manner that a quantity of light corresponding to the exposure level data is exposed to the photosensitive printing medium, thereby forming a pixel of a density corresponding to the exposure level data on the photosensitive printing medium. With this arrangement, there is an advantage that an image of high quality can be obtained.

Preferably, the photosensitive printing medium has a nonlinear chromophore density characteristic in which the density of a color generated in accordance with a quantity of exposure light is nonlinear with respect to the quantity of exposure light, and the exposure level conversion section converts the image data into the exposure level data in such a manner that the density of a pixel formed on the photosensitive printing medium corresponding to the exposure level data is linear with respect to the image data corresponding to the exposure level data. This arrangement is advantageous in that a high-quality image can be obtained.

Preferably, upon exposure of each element of the print head, the quantity of light per unit time of each element is constant, and the head driving section drives each element of the print head in such a manner that the exposure time of each element is proportional to the magnitude of the exposure level data. Thus, a high-quality image can be achieved with a simple construction.

Preferably, the exposure level conversion section includes an exposure level conversion table for correlating the image data and the exposure level data with respect to each other. Accordingly, a high-quality image can also be attained with a simple construction.

Preferably, the image data indicates the density of each of three primary colors for a plurality of pixels forming a color image with the first gradation value for each pixel. The exposure level conversion section converts the image data input thereto into corresponding exposure level data for each color which is indicative of the density of each color of each pixel represented by the image data with a second gradation value greater than the first gradation value for each color. The head driving section receives the exposure level data for each color and drives each element of the print head to expose the photosensitive printing medium in such a manner that a quantity of light corresponding to the exposure level data is exposed to the photosensitive printing medium, thereby forming a pixel of a density for each color corresponding to the exposure level data for each color on the photosensitive printing medium. This arrangement provides an advantage that even if there are variations in the characteristics of the elements of the print head, a color image of high quality can be obtained.

Preferably, the optical printing apparatus further comprises an exposure level correction section for correcting exposure level data output from the exposure level conversion section by a correction factor for each element of the print head, and outputting a corrected exposure level. The head driving section receives the corrected exposure level and drives each element of the print head to expose the photosensitive printing medium in such a manner that a quantity of light corresponding to the input corrected exposure level is exposed to the photosensitive printing medium, thereby forming a pixel of a density corresponding to the corrected exposure level data on the photosensitive printing medium. This arrangement is advantageous in that even if variations exist in the characteristics of the elements of the print head, there can be obtained a color image of high quality.

Preferably, the exposure level correction section comprises: a correction factor storing section for storing a correction factor for each element of the print head; a table describing corrected exposure level data while correlating each correction factor and exposure level data with respect to each other. The exposure level correction section determines corrected exposure level data from a correction factor read out from the correction factor storing section and an input exposure level data while referring to the table, and outputs the corrected exposure level data thus determined. This arrangement provides an advantage that an image of high quality can be obtained with a simple construction.

Preferably, the exposure level correction section comprises: a correction factor storing section for storing a correction factor for each element of the print head; and a multiplier for multiplying the correction factors and exposure level data. The exposure level correction section determines corrected exposure level data from a correction factor read out from the correction factor storing section and an input exposure level data, and outputs the corrected exposure level data thus determined. This arrangement is advantageous in that a high-quality image can be obtained with a simple construction.

Preferably, the optical printing apparatus further comprises: an accumulated exposure time information storing section for storing accumulated exposure time information corresponding to an accumulated exposure time of the print head; and an exposure level correcting section for correcting exposure level data output from the exposure level conversion section in accordance with accumulated exposure time information output from the accumulated exposure time information storing section, and for outputting the thus corrected exposure level data. The head driving section receives the corrected exposure level and drives each element of the print head to expose the photosensitive printing medium in such a manner that a quantity of light corresponding to the input corrected exposure level is exposed to the photosensitive printing medium, thereby forming a pixel of a density corresponding to the corrected exposure level data on the photosensitive printing medium. This arrangement is advantageous in that image printing with high quality can be achieved even if the print head is subjected to a secular change.

What is claimed is:

1. An optical printing apparatus in which an image data indicative of a density of each of a plurality of pixels forming an image with a first gradation value is input, so that a plurality of exposure elements of a print head are each driven to perform an exposure with a required quantity of exposure light (i.e., product of a quantity of light and an exposure time), thereby forming a pixel corresponding to each of said exposure elements on a photosensitive printing medium which generates a color of a density corresponding to said required quantity of exposure light, said apparatus comprising:
an exposure level conversion section for converting said image data into corresponding exposure level data indicative of a density of each pixel with a second gradation value greater than said first gradation value indicated by said image data, and for outputting the exposure level data thus converted; and
a head driving section being connected to receive said exposure level data from said exposure level conversion section and driving, based on said exposure level data, each element of said print head to expose said photosensitive printing medium in such a manner that a quantity of light corresponding to said exposure level data is exposed to said photosensitive printing medium, thereby forming a pixel of a density corresponding to said exposure level data on said photosensitive printing medium.

2. The optical printing apparatus as claimed in claim 1, wherein said photosensitive printing medium has a nonlinear chromophore density characteristic in which the density of a color generated in accordance with a quantity of exposure light is nonlinear with respect to the quantity of exposure light, and
said exposure level conversion section converts said image data into said exposure level data in such a manner that the density of a pixel formed on said photosensitive printing medium corresponding to said exposure level data is linear with respect to the image data corresponding to said exposure level data.

3. The optical printing apparatus as claimed in claim 1, wherein upon exposure of each element of said print head, the quantity of light per unit time of each element is constant, and said head driving section drives each element of said print head in such a manner that the exposure time of each element is proportional to the magnitude of said exposure level data.

4. The optical printing apparatus as claimed in claim 1, wherein said exposure level conversion section includes an exposure level conversion table for correlating said image data and said exposure level data with respect to each other.

5. The optical printing apparatus as claimed in claim 1, wherein said image data indicates the density of each of three primary colors for a plurality of pixels forming a color image with said first gradation value for each pixel, and
said exposure level conversion section converts said image data input thereto into corresponding exposure level data for each color which is indicative of the density of each color of each pixel represented by said image data with a second gradation value greater than said first gradation value for each color, and
said head driving section receives said exposure level data for each color and drives each element of said print head to expose said photosensitive printing medium in such a manner that a quantity of light corresponding to said exposure level data is exposed to said photosensitive printing medium, thereby forming a pixel of a density for each color corresponding to said exposure level data for each color on said photosensitive printing medium.

6. The optical printing apparatus as claimed in claim 1, further comprising:
an exposure level correction section for correcting exposure level data output from said exposure level conversion section by a correction factor for each element of said print head, and outputting a corrected exposure level,
wherein said head driving section receives said corrected exposure level and drives each element of said print head to expose said photosensitive printing medium in such a manner that a quantity of light corresponding to said input corrected exposure level is exposed to said photosensitive printing medium, thereby forming a pixel of a density corresponding to said corrected exposure level data on said photosensitive printing medium.

7. The optical printing apparatus as claimed in claim 6, wherein said exposure level correction section comprises:
a correction factor storing section for storing a correction factor for each element of said print head; and
a table describing corrected exposure level data while correlating each correction factor and exposure level data with respect to each other;
wherein said exposure level correction section determines corrected exposure level data from a correction factor read out from said correction factor storing section and an input exposure level data while referring to said table, and outputs said corrected exposure level data thus determined.

8. The optical printing apparatus as claimed in claim 6, wherein said exposure level correction section comprises:
a correction factor storing section for storing a correction factor for each element of said print head; and
a multiplier for multiplying said correction factors and exposure level data;
wherein said exposure level correction section determines corrected exposure level data from a correction factor read out from said correction factor storing section and an input exposure level data, and outputs the corrected exposure level data thus determined.

9. The optical printing apparatus as claimed in claim 1, further comprising:
an accumulated exposure time information storing section for storing accumulated exposure time information corresponding to an accumulated exposure time of said print head; and
an exposure level correcting section for correcting exposure level data output from said exposure level conversion section in accordance with accumulated exposure time information output from said accumulated exposure time information storing section, and for outputting the thus corrected exposure level data;
wherein said head driving section receives said corrected exposure level and drives each element of said print head to expose said photosensitive printing medium in such a manner that a quantity of light corresponding to said input corrected exposure level is exposed to said photosensitive printing medium, thereby forming a pixel of a density corresponding to said corrected exposure level data on said photosensitive printing medium.
